(19) United States
(12) Patent Application Publication
(10) Pub. No.: US 2012/0024150 A1
(43) Pub. Date: Feb. 2, 2012

(54) Biogas Conditioning System and Method

(76) Inventor: David Moniot, Cranberry Township, PA (US)

(21) Appl. No.: 13/008,558

(22) Filed: Jan. 18, 2011

Related U.S. Application Data
(60) Provisional application No. 61/369,362, filed on Jul. 30, 2010.

(51) Int. Cl. B01D 53/30; B01D 53/02

(52) U.S. Cl. 95/11; 96/111

(57) ABSTRACT

The present invention provides a system and process for the automatic conditioning of biogas to remove a wide range of contaminants including, for example, moisture, hydrogen sulfide, mercaptans, and NMOCs all in a single step. The biogas is passed through one or more vessels containing at least three different types of physical adsorbents. Contaminants in the biogas are removed from the biogas via physical adsorption onto the surfaces of the various media. Multiple media types are used in each vessel as different contaminants adsorb more or less onto various adsorbent media. The final proportions and types of media used are based on each particular biogas range of contaminants. Multiple vessels are used such that one or more vessels are always on-line and conditioning biogas, while one or more vessels is always off-line and either being reactivated or in standby service mode.

### CROSS-REFERENCE TO RELATED APPLICATIONS

This application claims the benefit of co-pending Provisional Patent Application Ser. No. 61/369,362 entitled “Biogas Conditioning System”, filed on Jul. 30, 2010, the entire disclosure of which is incorporated by reference herein.

### FIELD OF THE INVENTION

The present invention is directed toward systems and processes for removing contaminants and other unwanted materials from biogas and, in particular, toward systems and processes for removing, for example, hydrogen sulfide, mercaptans, and non-methane organic compounds (“NMOCs”), including, for example, organosilicates, from biogases released from, for example, landfills and wastewater treatment plants.

### BACKGROUND OF THE INVENTION

Biogas fuels derived from various sources, such as landfills and wastewater treatment plant anaerobic digesters, can be used, if properly conditioned, as a fuel source in various equipment, such as in an engine to generate electricity and/or heat. These biogas fuels can be burned or combusted in equipment including, but not limited to, boilers, fuel cells, micro-turbines, turbines, gas turbine engines, internal combustion engines and other prime-movers. As used herein, the term “prime mover” will be used to designate any device or engine that can burn conditioned biogas. Additionally, the term “prime mover” can also mean a storage device where the conditioned biogas is stored prior to being used in an engine, etc. Any of these devices/engines can be connected to an electric generator to generate electricity or connected to a shaft to provide shaft power for a variety of applications. If connected to an electric generation, the electricity produced could either be exported to an electric utility grid or used locally to power various on-site electric loads. Additionally, waste heat from the combustion process can also be used to heat water or other fluids.

The biogases contain constituents, contaminants and other unwanted materials that can cause problems in the prime mover. These contaminants include, among other things, moisture, hydrogen sulfide, mercaptans and non-methane organic compounds (“NMOCs”), including organosilicates. As used herein, “constituent” and “contaminant” is used to mean any material or ingredient that is desired to be removed from the biogas.

In particular, hydrogen sulfide and certain NMOCs, when combusted, form precipitates, deposits and acids which cause excessive wear on engine parts such as turbine blades, cylinders and heat exchangers. These precipitates, deposits and/or acids also blind, or poison, selective catalytic reduction (“SCR”) catalysts and carbon monoxide (“CO”) removal catalysts. These unwanted contaminants, when combusted, increase the abrasion of engine surfaces, leading to a loss of engine efficiency, premature engine failure, and/or fouling of SCR and CO catalysts, rendering them essentially useless.

Previous attempts at removing contaminants from biogas have used single adsorbents, such as activated charcoal, and have focused on removing only a small fraction of the biogas contaminants that are detrimental to combustion engines and other prime movers. Additionally, conventional treatment processes have been expensive and the results have been marginal.

Improved techniques for removing as many of the biogas contaminants (e.g., moisture, hydrogen sulfide, NMOCs, etc.) in one processing step, combined with an at-line, near real-time process monitoring and control device is needed. Contaminant removal and monitoring is needed that can continuously measure output biogas purity to ensure a continuous supply of conditioned biogas to combustion engines and other prime movers.

The present invention is directed toward overcoming one or more of the above-identified problems.

### SUMMARY OF THE INVENTION

The present invention, also referred to as a gas conditioning skid, provides a system and process for the fully automatic conditioning of biogas to remove a wide range of contaminants including, for example, moisture, hydrogen sulfide, mercaptans and NMOCs all in a single step. The raw biogas is passed through multiple vessels containing, in one embodiment, at least three types of physical adsorbents. Contaminants in the biogas are removed from the biogas via physical adsorption onto the surfaces of the various media, as opposed to absorption which is a bond onto the media particle. Adsorption is the attraction and adhesion of atoms, ions, biomolecules or molecules of gas, liquid or dissolved solids to a surface of the media, thus creating a film of the adsorbate (the molecules or atoms being accumulated) on the surface of the adsorbate (the media). On the other hand, absorption is the incorporation of a substance in one state into another of a different state (e.g., liquids being absorbed by a solid or gases being absorbed by a liquid). Multiple media types are used in each vessel as different contaminants adsorb more or less onto various different adsorbent media. The final proportions and types of media used are based on each particular biogas range of contaminants, and all proportions and types of media may be implemented within the spirit and scope of the present invention. Multiple vessels are used such that one or more vessels are always on-line and conditioning biogas, while one or more vessels are always off-line and either being reactivated or in standby service mode.

The present invention also provides an at-line, near real-time process control device to continuously monitor the outlet of the inventive system for the presence of contaminants, including, for example, hydrogen sulfide and NMOCs, to ensure quality effluent characteristics as well as to control the frequency of process reactivation cycles. When the media within a vessel(s) becomes saturated with contaminants and loses its ability to remove the contaminants from the raw biogas to acceptable levels, the media is reactivated by, for example, passing a hot gas through the vessel in a reverse flow direction to remove the adsorbed contaminants from the media. The process control device is used to determine the need to reactivate and to automatically control the switching of vessels and the start of individual vessel reactivation.

In one form, a biogas conditioning system is provided that includes a plurality of biogas conditioning vessels, each of the plurality of biogas conditioning vessels including an inlet connected to a source of raw biogas, an outlet connected to a prime mover device, and adsorption media therein for removing contaminants from the biogas, wherein the biogas conditioning vessels are switchable between an on-line mode for conditioning biogas, a standby mode, and a reactivation mode for reactivating the adsorption media therein, and a process control device monitoring the contaminant levels of the conditioned biogas at the outlet of the plurality of biogas conditioning vessels. The process control device initiates a reactivation sequence upon detecting that the contaminant level of the conditioned biogas is above a predetermined value. The reactivation sequence includes switching at least one of the biogas conditioning vessels in the on-line mode to the reactivation mode and, if needed, switching at least one of the biogas conditioning vessels in the standby mode to the on-line mode or switching at least one of the biogas conditioning vessels that has completed the reactivation mode to the on-line mode, such that at any one time at least one of the biogas conditioning vessels is in the on-line mode conditioning the raw biogas.

In a preferred form, each of the plurality of biogas conditioning vessels includes at least three different types of adsorbent media therein for conditioning the raw biogas.

At the raw gas inlet side, a coalescing filtering is provided for receiving and filtering the raw biogas prior to the raw biogas being conditioned by the plurality of biogas conditioning vessels. At the conditioned gas outlet side, a coalescing filter is also provided for receiving and filtering the conditioned biogas from the plurality of biogas conditioning vessels prior to the conditioned biogas being provided to the prime mover. Typically, the coalescing filters remove moisture from the raw/conditioned biogas.

In a further form, the process control device includes a plurality of process control devices corresponding to the plurality of biogas conditioning vessels, with each biogas conditioning vessel having a process control device at its outlet monitoring the contaminant level of the conditioned biogas output therefrom.

Each of the plurality of biogas conditioning vessels includes biogas input and output valves and reaction gas input and output valves. The reactivation sequence includes controlling, by the process control device, these valves to place the respective biogas conditioning vessels in either the on-line mode, the reactivation mode or the standby mode.

In yet a further form a control device is connected to the reaction gas output valves, the control device monitoring reaction gas output from the plurality of biogas conditioning vessels during the reactivation mode and determining when the reactivation mode is complete for a vessel or vessels being reactivated.

The control device can include a plurality of control devices corresponding to the plurality of biogas conditioning vessels, with each biogas conditioning vessel having a control device at its reactivation outlet monitoring the reactivation gas output therefrom.

The predetermined value for determining when as biogas conditioning vessel has reached or is near a saturation level or needs to be reactivated can be chosen to be a percentage of the contaminant threshold value of the prime mover.

In application of the reactivation sequence, the process control device determines which of the plurality of vessels to activate to the on-line mode depending upon the measured contaminant level of the conditioned biogas output from the system and the number of biogas conditioning vessels available for activation to the on-line mode.

In yet a further form, the process control device monitors the contaminant level of the conditioned biogas output from each biogas conditioning vessel via individual sample lines from each of the plurality of biogas conditioning vessels.

If two or more biogas conditioning vessels are in the on-line mode of operation at the same time, run times of each biogas conditioning vessel are staggered such that one vessel will always be running longer than the others, wherein the process control device determines which of the plurality of vessels to activate to the on-line mode depending upon the measured contaminant level of the conditioned biogas output from the system, the number of biogas conditioning vessels available for activation to the on-line mode, and the run time of each vessel.

In another form, a method of conditioning biogas is provided which includes the steps of providing a plurality of biogas conditioning vessels, each of the plurality of biogas conditioning vessels including an inlet connected to a source of raw biogas, an outlet connected to a prime mover device, and adsorption media therein for removing contaminants from the biogas, wherein the biogas conditioning vessels are switchable between an on-line mode for conditioning biogas, a standby mode, and a reactivation mode for reactivating the adsorption media therein; conditioning, by the plurality of biogas conditioning vessels, the raw biogas to remove contaminants therefrom to produce a conditioned biogas; measuring a contaminant level of the conditioned biogas output from the plurality of biogas conditioning vessels; and upon detecting that the contaminant level of the conditioned biogas is above a predetermined value, initiating a reactivation sequence including switching at least one of the biogas conditioning vessels in the on-line mode to the reactivation mode and, if needed, switching at least one of the biogas conditioning vessels in the standby mode to the on-line mode or switching at least one of the biogas conditioning vessels that has completed the reactivation mode to the on-line mode, such that at any one time at least one of the biogas conditioning vessels is in the on-line mode conditioning the raw biogas. The predetermined value may be chosen as a percentage of the contaminant threshold value of the prime mover.

In one form, the method further includes the steps of filtering moisture from the raw biogas prior to the raw biogas being conditioned by the plurality of biogas conditioning vessels, and/or filtering moisture from the conditioned biogas prior to the conditioned biogas being provided to the prime mover.

The measuring step includes measuring the contaminant level of the conditioned biogas from each of the plurality of biogas conditioning vessels individually.

In a further form, the method further includes the step of monitoring reaction gas output from the plurality of biogas conditioning vessels during the reactivation mode and determining when the reactivation mode is complete for a vessel or vessels being reactivated. The monitoring step may include monitoring the reaction gas output from each of the plurality of biogas conditioning vessels in the reactivation mode individually.

In yet a further form the reactivation sequence includes determining which of the plurality of vessels to activate to the on-line mode depending upon, among other things, the measured contaminant level of the conditioned biogas output from the plurality of biogas conditioning vessels and the number of biogas conditioning vessels available for activation to the on-line mode.

It is an object of the present invention to provide for the conditioning of biogas to remove a wide range of contaminants including, for example, moisture, hydrogen sulfide, mercaptans and NMOCs all in a single step.

It is a further object of the present invention to provide for the automatic conditioning of biogas to remove a wide range of contaminants including, for example, moisture, hydrogen sulfide, mercaptans, and NMOCs all in a single step.

It is yet a further object of the present invention to provide a less expensive and/or less complicated system and method for the conditioning of biogas to remove a wide range of contaminants.

It is still a further object of the present invention to provide for the conditioning of biogas to remove a wide range of contaminants such that the biogas is acceptable to burn in various prime mover equipment.

Other objects, aspects and advantages of the present invention can be obtained from a study of the specification, the drawings, and the appended claims.

### BRIEF DESCRIPTION OF THE DRAWINGS

The various preferred embodiments of the present invention will be described in detail with reference to the following figures.

FIG. 1 is a schematic of a multi-vessel gas conditioning skid in normal operation with vessels 100 and 200 in service (“on-line”) and vessel 300 is standby mode;

FIG. 2 is a schematic of a multi-vessel gas conditioning skid in normal operation with vessel 100 being reactivated and vessels 200 and 300 in service;

FIG. 3 is a schematic of a multi-vessel gas conditioning skid in normal operation with vessel 200 being reactivated and vessels 100 and 300 in service; and

FIG. 4 is a schematic of a multi-vessel gas conditioning skid in normal operation with vessel 300 being reactivated and vessels 100 and 200 in service.

### DETAILED DESCRIPTION OF THE INVENTION

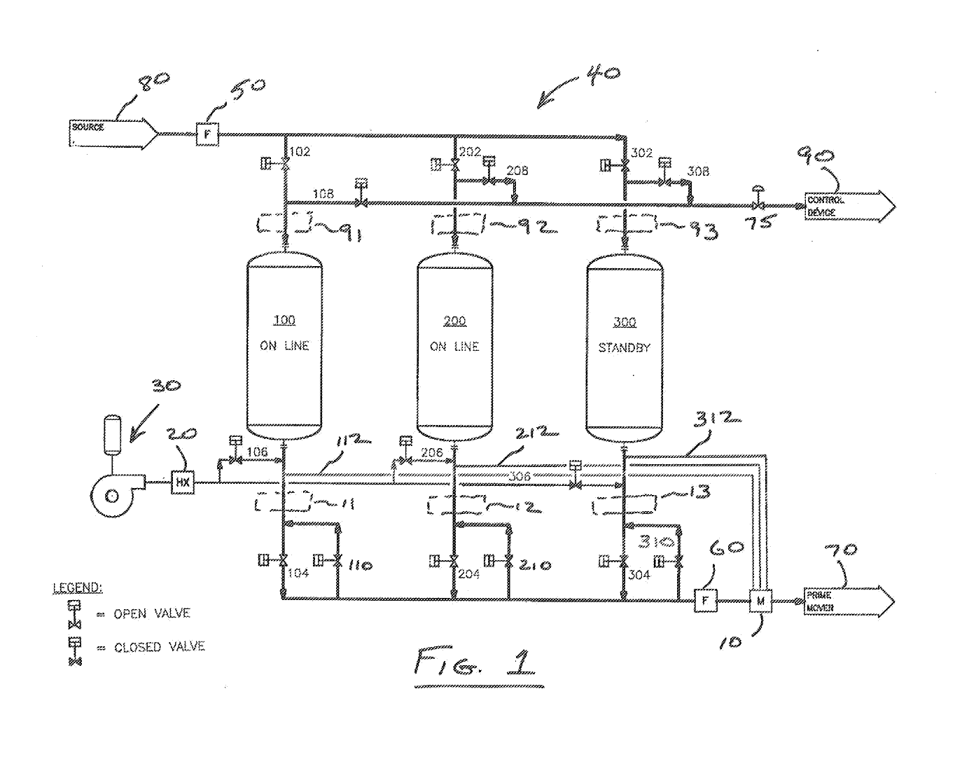

The present invention removes various contaminants from biogas, as summarized above and illustrated in FIGS. 1-4, by passing the biogas through one or more vessels 100, 200, 300 containing various adsorbent materials including, but not limited to, silica gels, aluminum oxides and zeolites. Adsorbent materials utilized to remove contaminants from biogas as known in the industry and, thus, a more detailed description of such materials is not necessary. Additionally, the present invention is in no way limited to the materials or types of adsorbents used, and any media may be utilized in the vessels without departing from the spirit and scope of the present invention. In accordance with the present invention, one or more vessels are always on-line processing raw biogas, while one or more vessels are either in reactivation/regeneration mode or in standby service mode. The raw biogas enters the vessel(s) and the contaminants are adsorbed onto the adsorption media as the raw biogas moves through the vessel(s), and conditioned biogas leaves the vessel(s).

The conditioned biogas is continuously analyzed for contaminants via a conventional process control device 10 (e.g., a gas chromatograph) using, for example, gas chromatography-photo ionization detection to ensure biogas purity. However, the present invention is in no way limited to the specific process control device utilized, and any process control device may be used to analyze the conditioned biogas leaving the vessel(s) without departing from the spirit and scope of the present invention. As used herein, the term “biogas” refers to a gas produced by the decomposition of organic matter. As used herein, a “biogas” can be obtained from various sources, such as, for example, landfills and wastewater treatment anaerobic digesters.

When the process control device 10 has measured that the output, conditioned biogas has a contaminant concentration at or above a predetermined threshold, it reports that the adsorption media has become saturated with contaminants and the flow of raw biogas through the vessel or vessels is automatically switched to a standby vessel or vessels and flow through the current, saturated on-line vessel or vessels is stopped. The saturated vessel or vessels (now off-line) undergoes a reactivation or regeneration cycle by, for example, passing a reactivation gas through the adsorption media in a reverse direction to the biogas flow and removing adsorbed contaminants from the adsorption media. Reactivation, or regeneration, removes the adsorbed material from the media surface so the media can again attract contaminants out of the biogas. Once the vessel or vessels has become “regenerated”, it can be placed in a standby mode of operation where it waits to be activated to again process the raw biogas. It should be understood that the present invention is in no way limited to the specific reactivation or regeneration process utilized, and any reactivation/regeneration process may be used to “regenerate” the vessel(s) without departing from the spirit and scope of the present invention.

The system or device of the present invention may be carried on a base or skid (hence the reference to a “gas conditioning skid”), resulting in the system being a unitary facility, which may be shipped and installed easily. The gas conditioning skid of the present invention can be made of any suitable material. To minimize corrosion due to acid gases, such as carbon dioxide, hydrogen sulfide, etc., the various vessels, pipe, valves, devices, etc. in the system can be made with 304L or 316L stainless steel.

The adsorption media may be in the form of beads and/or pellets and, in one form of the present invention, three different media types are used in each vessel. It should be understood that other forms and types of media and various combinations of pluralities of different media are also contemplated within the spirit and scope of the present invention.

The reactivation gas can be any gas that does not react with the adsorption media. Typically, the reactivation gas is heated air. However, the present invention is in no way limited to the specific reactivation gas utilized, and other types of reactivation gasses may be used without departing from the spirit and scope of the present invention. The reactivation gas is typically heated before coming in contact with the adsorption media. The heating of the reactivation gas may be accomplished using electrical, or other, heaters 20 which contact and heat the reactivation gas (e.g., air). Such heating can also be accomplished using, for example, gas-to-gas or gas-to-liquid heat exchangers. During reactivation/regeneration, the adsorption media is typically heated to a temperature in the range of 300° F. to 455° F. Reactivation is typically considered complete when the adsorption media within the vessel(s) is within this temperature range (300° F. to 455° F.) and the vessel outlet gas temperature is within 30° F. to 80° F. of the media temperature within the vessel being reactivated.

A compressor and/or blower 30 are used to move the heated reactivation gas through the vessel(s) 100, 200, 300. The compressor and/or blower 30 pushes the reactivation gas through the heater and/or heat exchanger 20 and the vessel(s) 100, 200, 300 counter to the direction of biogas flow during gas conditioning.

Having generally described the present invention, reference is now made to the following example, which is provided for the purpose of illustration only and is not intended to be limiting.

### Example

### Multi-Vessel Gas Conditioning Skid

FIGS. 1-4 illustrate a three vessel gas conditioning skid, shown generally at 40. It should be understood, however, that any number of vessels may be utilized in accordance with the spirit and scope of the present invention. The system 40 generally includes an inlet coalescing filter 50, an outlet coalescing filter 60, a vessel 100, a vessel 200, and a vessel 300, where each vessel 100, 200, 300 contains various adsorption media. Coalescing filters 50 and 60 are used to dry the biogas by separating liquid aerosols and droplets from the biogas. The system 40 also includes a process control device 10 which monitors biogas contaminant levels in the output conditioned biogas prior to the conditioned biogas flowing to the prime mover device 70. The process control device 10 also includes, or is operationally connected to, hardware and software used to manage and control the various valves for the automatic switching of vessels for reactivation/regeneration. The system 40 also includes a general shut off valve 75.

Vessel 100 includes a biogas input valve 102, a biogas output valve 104, a reactivation gas input valve 106 and a reactivation gas output valve 108. Vessel 200 includes a biogas input valve 202, a biogas output valve 204, a reactivation gas input valve 206 and a reactivation gas output valve 208. Vessel 300 includes a biogas input valve 302, a biogas output valve 304, a reactivation gas input valve 306 and a reactivation gas output valve 308. Biogas input valves 102, 202 and 302 are connected together and, similarly, biogas output valves 104, 204 and 304 are connected together. Each of the vessels 100, 200, 300 also includes air cleanout valves 110, 210, 310 connected in parallel with the respective output valves 104, 204, 304. The air cleanout valves are used to remove air from the vessel 100, 200, 300 prior to bringing it back on-line after a regeneration sequence. Since regeneration is done with air, the air is needed to be removed from the vessel 100, 200, 300 before it is brought back on-line. Otherwise, allowing the air to remain in the vessel 100, 200, 300 may cause a prime mover 70 shutdown when the vessel 100, 200, 300 is brought back on-line due to too lean a gas mixture. Once the regeneration sequence is complete, the respective air cleanout valve 110, 210, 310 is open and pressurized clean gas sweeps through the vessel 100, 200, 300 and sends the air/biogas mixture to a conventional flare (not shown). Once the air is displaced from the vessel 100, 200, 300 it is ready for on-line service. If additional vessels are implemented in the inventive system, they will also have similar valves and similar connections.

In the described embodiment, at biogas input valves 102, 202 and 302, the biogas will typically have a pressure in a range of from 5 psig to 300 psig; a temperature in a range of from 34° F. to 125° F.; and a relative humidity (RH) at 75° F. dry bulb in a range of from 10% to 100% RH and, more preferably, from 10% to 30% RH. However, it should be understood that other pressure, temperature and relative humidity values and ranges are contemplated.

As shown in FIG. 1, initially vessels 100 and 200 are used to condition the raw biogas, while vessel 300 is in a standby mode waiting to be activated. As such, biogas input 102, 202 and output 104, 204 valves are open, while biogas input 302 and output 304 valves are closed. Since no vessels are being reactivated, all reactivation gas input 106, 206, 306 and output 108, 208, 308 valves are closed. Raw biogas from a source 80 enters the gas conditioning skid 10 and flows first through the coalescing filter 50 and then into vessels 100 and 200 via biogas input valves 102 and 202, respectively. In one form, approximately 50% of the biogas flow is directed to each vessel 100 and 200. If necessary, the biogas can be forced from biogas source 80 into the vessels 100 and 200 by a conventional gas mover (not shown), such as, for example, a blower or a compressor.

In vessels 100 and 200, contaminants in the biogas are adsorbed onto the adsorption media provided in the vessels 100 and 200. Conditioned biogas then leaves the vessels 100 and 200 via biogas output valves 104 and 204, respectively. The conditioned biogas is filtered via coalescing filter 60 to generally remove moisture from the conditioned biogas. The conditioned biogas also passes through the process control device 10, which monitors the contaminant level in the conditioned biogas. The conditioned biogas then leaves the skid 40 is provided to the prime mover 70 for combustion to produce electricity, energy, heat, etc.

Eventually, the adsorption media in vessels 100 and 200 will become saturated with contaminants and need to be reactivated/regenerated. The determination of saturation is made by the process control device 70, which monitors the contaminant level in the conditioned biogas. When the process control device 70 senses that the conditioned biogas contaminant concentration level is at or exceeds a predetermined value, a reactivation sequence is automatically initiated. For example, the predetermined value may be 75% of the contaminant threshold value, or some other percentage of the contaminant threshold value. The contaminant threshold value is set by the system operator based on the prime mover 70 requirements. The contaminant threshold value is a concentration in parts per million by volume (“ppmv”) and may be of one item or a sum of several of the various non-methane organic compounds.

The reactivation sequence includes first isolating the contaminant-saturated vessel from the biogas source 80. Preferably the vessel to be reactivated is then conventionally brought to atmospheric pressure conditions before starting the reactivation cycle.

Reactivation can be accomplished in a variety of ways. In one form, a reactivation gas is forced through the vessel having the contaminant-saturated adsorption media using a gas mover 30. In embodiments of the present invention, the gas mover 30 is one or more of a blower and/or a compressor. The gas reactivation path is generally counter to the direction of biogas flow during biogas conditioning.

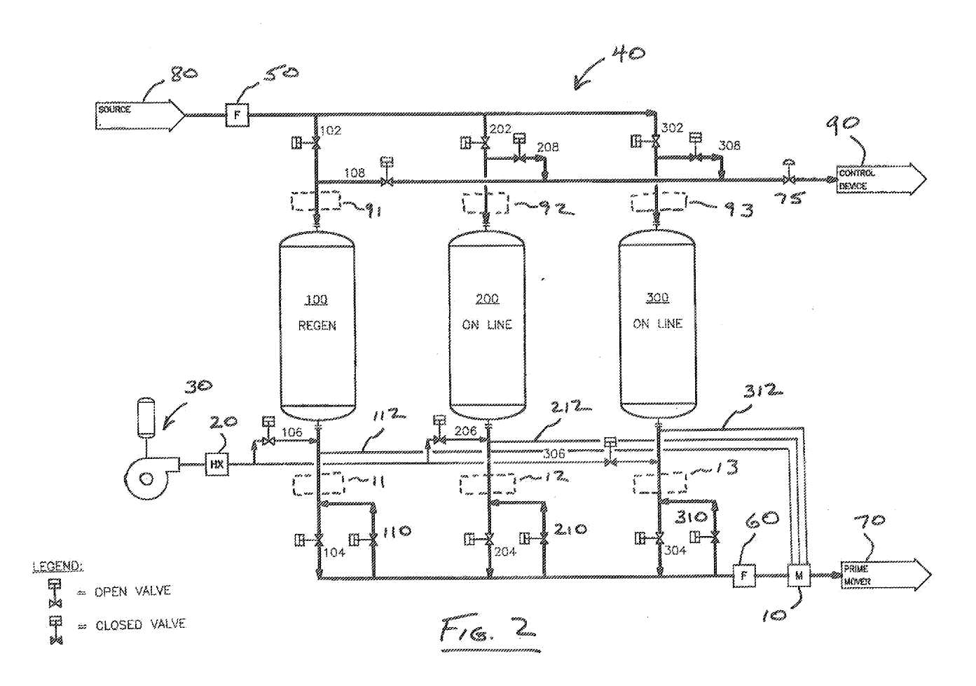

FIGS. 2-4 illustrate the reactivation of vessels 100, 200 and 300, respectively. In the embodiment of FIG. 2, once the process control device 10 senses that the contaminant level of the conditioned biogas is above a preset value, it will automatically initiate a reactivation sequence to reactive vessel 100 by conventionally controlling the opening and closing of select valves. For example, to reactivate vessel 100, the process control device 10 will cause biogas input 102 and output 104 valves to close, and reactivation gas input 106 and output 108 valves to open. To activate vessel 300 from the standby mode to an on-line mode, the process control device 10 causes biogas input 302 and output 304 valves to open. While vessel 100 is being reactivated, the flow of biogas from the biogas source 80, previously received by vessel 100, is redirected to vessel 300, while vessel 200 continues to receive biogas for removal of contaminants. Again, typically, the flow of biogas will be split 50-50 between vessels 200 and 300. Concurrently with the redirection of the input biogas, the source of conditioned biogas to the prime mover 70 is switched from biogas output valve 104 of vessel 100 to biogas output valve 304 of vessel 300. Means of redirecting gas flows are well known in the art and include actuating the various valves. In FIG. 2, while the adsorption media is being reactivated in vessel 100, contaminants are being removed from the raw biogas in vessels 200 and 300.

In FIG. 2, reactivation of the adsorption media in vessel 100 by removal of the adsorbed contaminants is accomplished by blowing reactivation gas through vessel 100 using gas mover 30. In FIG. 2, the reactivation gas from gas mover 30 is heated by the reactivation gas heater 20 before entering the vessel 100. Control device 90 receives the output of the reactivation process and can conventionally determine with the reactivation cycle is complete.

After the adsorption media in vessel 100 is reactivated (as determined by the control device 90), the vessel 100 can either be reconnected to the biogas source 80 to remove contaminants from the biogas or placed in a standby mode. At the same time, vessel 200 can be disconnected from the biogas source 80 and reactivated using processes analogous to those described above.

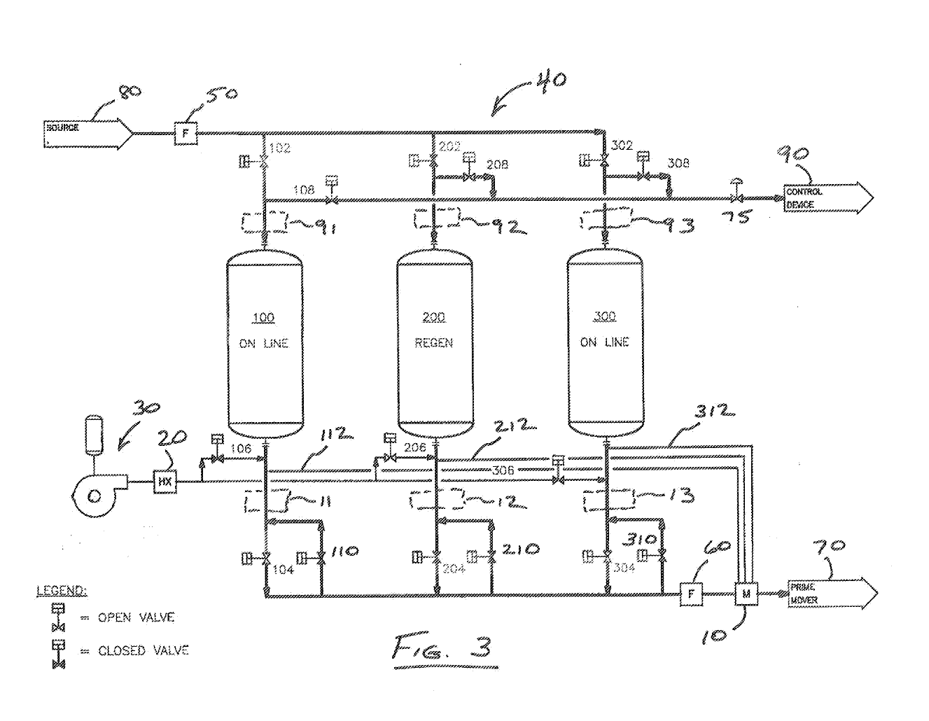

As shown in FIG. 3, in this example, the vessel 100 is placed back in an on-line mode of operation while vessel 200 is placed in a reactivation mode. This is accomplished by opening biogas input 102 and output 104 valves and closing reactivation gas input 106 and output 108 valves for vessel 100, while closing biogas input 202 and output 204 valves and opening reactivation gas input 206 and output 208 valves for vessel 200. While vessel 200 is being reactivated, the flow of biogas from the biogas source 80, previously received by vessel 200, is redirected to vessel 100, while vessel 300 continues to receive biogas for removal of contaminants. Again, typically, the flow of biogas will be split 50-50 between vessels 100 and 300. Concurrently with the redirection of the input biogas, the source of conditioned biogas to the prime mover 70 is switched from biogas output valve 204 of vessel 200 to biogas output valve 104 of vessel 100. In FIG. 3, while the adsorption media is being reactivated in vessel 200, contaminants are being removed from the raw biogas in vessels 200 and 300, which are in the biogas purification mode.

In FIG. 3, reactivation of the adsorption media in vessel 200 by removal of the adsorbed contaminants is accomplished in the same manner as previously described with respect to vessel 100 (see FIG. 2), namely, by blowing heated reactivation gas through vessel 200 using gas mover 30. Control device 90 receives the output of the reactivation process and can conventionally determine with the reactivation cycle of vessel 200 is complete.

After the adsorption media in vessel 200 is reactivated (as determined by the control device 90), the vessel 200 can either be reconnected to the biogas source 80 to remove contaminants from the biogas or placed in a standby mode. At the same time, vessel 300 can be disconnected from the biogas source 80 and reactivated using processes analogous to those described above.

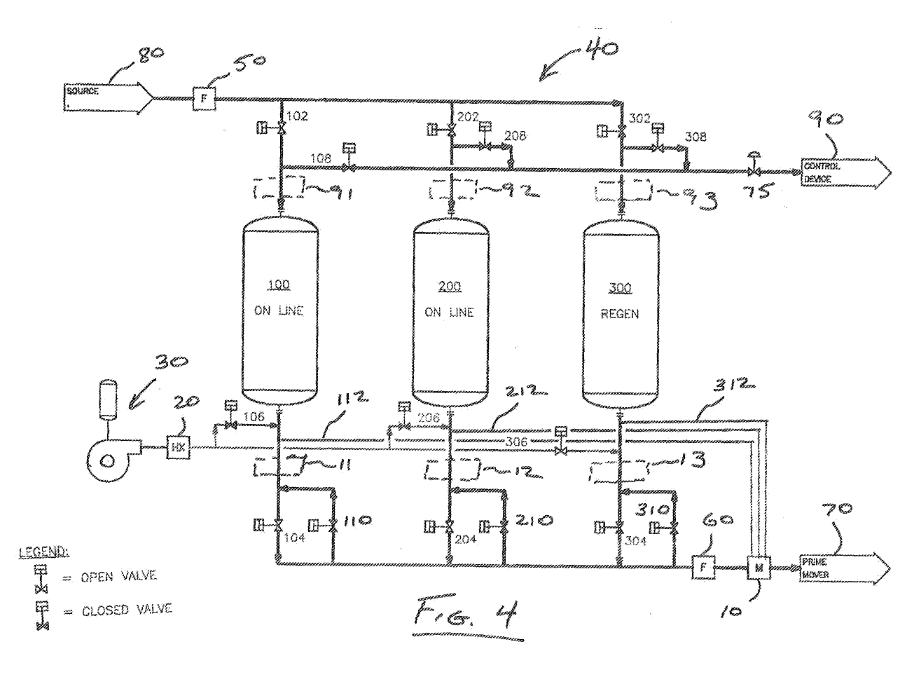

As shown in FIG. 4, in this example, the vessel 200 is placed back in an on-line mode of operation while vessel 300 is placed in a reactivation mode. This is accomplished by opening biogas input 202 and output 204 valves and closing reactivation gas input 206 and output 208 valves for vessel 200, while closing biogas input 302 and output 304 valves and opening reactivation gas input 306 and output 308 valves for vessel 300. While vessel 300 is being reactivated, the flow of biogas from the biogas source 80, previously received by vessel 300, is redirected to vessel 200, while vessel 100 continues to receive biogas for removal of contaminants. Again, typically, the flow of biogas will be split 50-50 between vessels 100 and 200. Concurrently with the redirection of the input biogas, the source of conditioned biogas to the prime mover 70 is switched from biogas output valve 304 of vessel 300 to biogas output valve 204 of vessel 200. In FIG. 4, while the adsorption media is being reactivated in vessel 300, contaminants are being removed from the raw biogas in vessels 100 and 200, which are in the biogas purification mode.

In FIG. 4, reactivation of the adsorption media in vessel 300 by removal of the adsorbed contaminants is accomplished in the same manner as previously described with respect to vessel 100 (see FIG. 2), namely, by blowing heated reactivation gas through vessel 300 using gas mover 30. Control device 90 receives the output of the reactivation process and can conventionally determine with the reactivation cycle of vessel 300 is complete.

After the adsorption media in vessel 300 is reactivated (as determined by the control device 90), the vessel 300 can either be reconnected to the biogas source 80 to remove contaminants from the biogas or placed in a standby mode. At the same time, vessels 100 and/or 200 can be disconnected from the biogas source 80 and reactivated using processes analogous to those described above.

The determination of whether to activate a vessel or vessels and which vessel or vessels to activate to the on-line mode is made by the process control device 10 depending various factors, such as the measured contaminant level of the conditioned biogas output from the skid 40 and the number of vessels available for activation to the on-line mode (e.g., either in standby mode or those where reactivation complete). Another factor in determining when to regenerate a vessel is time. In a preferred form, each vessel will be regenerated after approximately twenty-four (24) hours in service, although that can be extended to a forty-eight (48) max run time.

It one form, only one vessel at a time is placed in the on-line mode of operation for conditioning the biogas. If multiple vessels are running at the same time, their run times will be staggered, such that one will always be running longer (e.g., 24 hours) than the others to a maximum run time (e.g., 48 hours). Thus, in addition to regenerating the vessels when the measured contaminant level reaches a threshold level, the decision to regenerate a vessel can be made by the process control device based on the run times of the vessels. Monitoring the run times if each vessel is especially important when multiple vessels on in the on-line mode of operation at the same time.

In anther form of the present invention, as shown in FIGS. 1-4, the process control device 10 may be supplemented or replaced by individual process control devices 11, 12, 13 provided at each of the vessels 100, 200, 300. In this form, the process control devices 11, 12, 13 would monitor the contaminant level of the conditioned biogas output from a particular vessel 100, 200, 300 and can determine which vessel has reached a contaminant-saturation point. The output of the process control devices 11, 12, 13 would be sent to a central process control device (which could be process control device 10 or another device not shown) which would control the activation and reactivation sequence of vessels to ensure that at any one time at least one vessel was in a gas purification mode conditioning the raw biogas. This embodiment may find particular utility where a large number of vessels were being utilized to condition the biogas.

Similarly, the control device 90 may be supplemented or replaced by individual control devices 91, 92, 93 provided at each of the vessels 100, 200, 300. In this form, the control devices 91, 92, 93 would monitor the reactivation process of each particular vessel 100, 200, 300 and can determine which vessel has completed its reactivation cycle. The output of the control devices 91, 92, 93 would be sent to a central control device (which could be control device 90 or another device not shown) which would control the activation and reactivation sequence of vessels to ensure that at any one time at least one vessel was in a gas purification mode conditioning the raw biogas. Again, this embodiment may find particular utility where a large number of vessels were being utilized to condition the biogas.

In an alternate form, as shown in FIGS. 1-4, each vessel 100, 200, 300 includes its own sample line 112, 212, 312 at the output, which are fed to the process control device 10. In this manner, the process control device can determine which vessel 100, 200, 300 is in need of regeneration by analyzing the conditioned gas at each individual sample line 112, 212, 312.

In all cases, the inventive system and method operates such that at least one vessel is in a gas purification mode to condition the raw biogas. Thus, the decision to either activate a vessel or place it in a standby mode is chosen accordingly.

In all cases, the gas mover (e.g., blower) 30 and gas heater 20 are used for reactivation, regardless of the vessel or vessels being reactivated. While the above example describes only one vessel at a time being reactivated, it should be understood that at any one time, any number of vessels may be in reactivation mode, any number of vessels may be in standby mode, and any number of vessels may be in on-line mode.

In all cases, the adsorption media that has been heated during reactivation will have to be cooled before the reactivated adsorption media can again be used to remove contaminants from the raw biogas. The cooling is accomplished by pushing, with gas mover 30, unheated reactivation gas through the adsorption media counter to the biogas flow and venting the cooling gas to the atmosphere and/or an appropriate emissions control device (e.g., an enclosed ground flare).

Using the multi-vessel gas conditioning skid 10 of the present invention, contaminant removal and adsorption media reactivation is carried out cyclically in vessels 100, 200 and 300 to provide a continuous flow of conditioned biogas to the prime mover 70.

While the present invention has been described with respect to specific embodiments, it is not confined to the specific details set forth, but includes various changes and modifications that may suggest themselves to those skilled in the art, all falling within the spirit and scope of the present invention as defined by the following claims. Those skilled in the art will appreciate that various other modifications and alterations could be developed in light of the overall teachings of the disclosure. The presently preferred embodiments described herein are meant to be illustrative only and not limiting as to the scope of the invention which is to be given the full breadth thereof. Additionally, the disclosure herein of a range of values is a disclosure of every numerical value within that range.

I/We claim:

1. A biogas conditioning system comprising:
a plurality of biogas conditioning vessels, each of the plurality of biogas conditioning vessels including an inlet connected to a source of raw biogas, an outlet connected to a prime mover device, and adsorption media therein for removing contaminants from the biogas, wherein the biogas conditioning vessels are switchable between an on-line mode for conditioning biogas, a standby mode, and a reactivation mode for reactivating the adsorption media therein; and
a process control device monitoring the contaminant levels of the conditioned biogas at the outlet of the plurality of biogas conditioning vessels,
wherein the process control device initiates a reactivation sequence upon detecting that the contaminant level of the conditioned biogas is above a predetermined value, and
wherein the reactivation sequence includes switching at least one of the biogas conditioning vessels in the on-line mode to the reactivation mode and, if needed, switching at least one of the biogas conditioning vessels in the standby mode to the on-line mode or switching at least one of the biogas conditioning vessels that has completed the reactivation mode to the on-line mode, such that at any one time at least one of the biogas conditioning vessels is in the on-line mode conditioning the raw biogas.

2. The biogas conditioning system of claim 1, wherein each of the plurality of biogas conditioning vessels includes at least three different types of adsorbent media therein for conditioning the raw biogas.

3. The biogas conditioning system of claim 1, further comprising a coalescing filtering receiving and filtering the raw biogas prior to the raw biogas being conditioned by the plurality of biogas conditioning vessels.

4. The biogas conditioning system of claim 1, further comprising a coalescing filter receiving and filtering the conditioned biogas from the plurality of biogas conditioning vessels prior to the conditioned biogas being provided to the prime mover.

5. The biogas conditioning system of claim 1, wherein the process control device comprises a plurality of process control devices corresponding to the plurality of biogas conditioning vessels, with each biogas conditioning vessel having a process control device at its outlet monitoring the contaminant level of the conditioned biogas output therefrom.

6. The biogas conditioning system of claim 1, wherein each of the plurality of biogas conditioning vessels includes biogas input and output valves and reaction gas input and output valves, and wherein the reactivation sequence includes controlling, by the process control device, these valves to place the respective biogas conditioning vessels in either the on-line mode, the reactivation mode or the standby mode.

7. The biogas conditioning system of claim 6, further comprising a control device connected to the reaction gas output valves, the control device monitoring reaction gas output from the plurality of biogas conditioning vessels during the reactivation mode and determining when the reactivation mode is complete for a vessel or vessels being reactivated.

8. The biogas conditioning system of claim 7, wherein the control device comprises a plurality of control devices corresponding to the plurality of biogas conditioning vessels, with each biogas conditioning vessel having a control device at its reactivation outlet monitoring the reactivation gas output therefrom.

9. The biogas conditioning system of claim 1, wherein the predetermined value comprises a percentage of the contaminant threshold value of the prime mover.

10. The biogas conditioning system of claim 1, wherein the process control device determines which of the plurality of vessels to activate to the on-line mode depending upon the measured contaminant level of the conditioned biogas output from the system and the number of biogas conditioning vessels available for activation to the on-line mode.

11. The biogas conditioning system of claim 1, wherein the process control device monitors the contaminant level of the conditioned biogas output from each biogas conditioning vessel via individual sample lines from each of the plurality of biogas conditioning vessels.

12. The biogas conditioning system of claim 1, wherein if two or more biogas conditioning vessels are in the on-line mode of operation at the same time, run times of each biogas conditioning vessel are staggered such that one vessel will always be running longer than the others, wherein the process control device determines which of the plurality of vessels to activate to the on-line mode depending upon the measured contaminant level of the conditioned biogas output from the system, the number of biogas conditioning vessels available for activation to the on-line mode, and the run time of each vessel.

13. A method of conditioning biogas comprising:
providing a plurality of biogas conditioning vessels, each of the plurality of biogas conditioning vessels including an inlet connected to a source of raw biogas, an outlet connected to a prime mover device, and adsorption media therein for removing contaminants from the biogas, wherein the biogas conditioning vessels are switchable between an on-line mode for conditioning biogas, a standby mode, and a reactivation mode for reactivating the adsorption media therein;
conditioning, by the plurality of biogas conditioning vessels, the raw biogas to remove contaminants therefrom to produce a conditioned biogas;
measuring a contaminant level of the conditioned biogas output from the plurality of biogas conditioning vessels; and
upon detecting that the contaminant level of the conditioned biogas is above a predetermined value, initiating a reactivation sequence including switching at least one of the biogas conditioning vessels in the on-line mode to the reactivation mode and, if needed, switching at least one of the biogas conditioning vessels in the standby mode to the on-line mode or switching at least one of the biogas conditioning vessels that has completed the reactivation mode to the on-line mode, such that at any one time at least one of the biogas conditioning vessels is in the on-line mode conditioning the raw biogas.

14. The method of claim 13, wherein each of the plurality of biogas conditioning vessels includes at least three different types of adsorbent media therein for conditioning the raw biogas.

15. The method of claim 13, further comprising filtering moisture from the raw biogas prior to the raw biogas being conditioned by the plurality of biogas conditioning vessels.

16. The method of claim 13, further comprising filtering moisture from the conditioned biogas prior to the conditioned biogas being provided to the prime mover.

17. The method of claim 13, wherein the measuring step comprises measuring the contaminant level of the conditioned biogas from each of the plurality of biogas conditioning vessels individually.

18. The method of claim 17, wherein each biogas conditioning vessel includes a process control device at the output thereof for measuring the contaminant level of the conditioned biogas from each of the plurality of biogas conditioning vessels individually.

19. The method of claim 17, wherein each biogas conditioning vessel includes a sample line at the output thereof, where a process control device receives conditioned biogas from each biogas conditioning vessel via the sample lines for measuring the contaminant level of the conditioned biogas from each of the plurality of biogas conditioning vessels individually.

20. The method of claim 13, wherein each of the plurality of biogas conditioning vessels includes biogas input and output valves and reaction gas input and output valves, and wherein the reactivation sequence includes controlling these valves to place the respective biogas conditioning vessels in either the on-line mode, the reactivation mode or the standby mode.

21. The method of claim 20, further comprising monitoring reaction gas output from the plurality of biogas conditioning vessels during the reactivation mode and determining when the reactivation mode is complete for a vessel or vessels being reactivated.

22. The method of claim 21, wherein the monitoring step comprises monitoring the reaction gas output from each of the plurality of biogas conditioning vessels in the reactivation mode individually.

23. The method of claim 13, wherein the predetermined value comprises a percentage of the contaminant threshold value of the prime mover.

24. The method of claim 13, wherein the reactivation sequence comprises determining which of the plurality of vessels to activate to the on-line mode depending upon the measured contaminant level of the conditioned biogas output from the plurality of biogas conditioning vessels and the number of biogas conditioning vessels available for activation to the on-line mode.

25. The method of claim 13, wherein if two or more biogas conditioning vessels are in the on-line mode of operation at the same time, run times of each biogas conditioning vessel are staggered such that one vessel will always be running longer than the others, wherein the reactivation sequence comprises determining which of the plurality of vessels to activate to the on-line mode depending upon the measured contaminant level of the conditioned biogas output from the plurality of biogas conditioning vessels, the number of biogas conditioning vessels available for activation to the on-line mode, and the run time of each vessel.
